(19) United States
(12) Patent Application Publication
(10) Pub. No.: US 2026/0177401 A1
(43) Pub. Date: Jun. 25, 2026

(54) METHOD AND SYSTEM FOR GENERATING MAP DATA BASED ON ENHANCED IMAGES

(71) Applicant: HERE Global B.V., Eindhoven (NL)

(72) Inventors: Anto Felix IMMANUEL, Bangalore (IN); Abhishek PANDEY, New Delhi (IN); Deekshant SAXENA, Navi Mumbai (IN); Nitin MUKESH, Bihar (IN)

(21) Appl. No.: 18/999,970

(22) Filed: Dec. 23, 2024

(51) Int. Cl. G01C 21/00; G06V 10/82; G06V 20/13

(52) U.S. Cl. CPC G01C 21/3852; G01C 21/3826; G06V 10/82; G06V 20/13

(57) ABSTRACT

System for enhancing images receives image data associated with a first image associated with a geographical region. The first image has a first type. The system generates edge map data associated with the first image based on the image data, using a first neural network. The system generates a second image on the edge map data, using a second neural network. The second image has a second type different from the first type. The second neural network is trained on a latent representation of each of a plurality of training images associated with the second type. The system generates a third image based on the second image, using a third neural network. The third image has a first resolution higher than a second resolution of the second image. The system generates map data corresponding to the geographical region based on the third image.

### TECHNOLOGICAL FIELD

The present disclosure generally relates to map data generation, and more particularly relates to systems and methods for enhancing images with style matching for map data generation.

### BACKGROUND

Images are utilized in feature extraction, in footprint detection, object detection, map making and in various other processes associated with the creation of a map database. Typically, satellite images may be utilized for generating the map data. The availability of satellite image data for various geographical regions, including certain remote regions, enables generation of map data for various regions. However, poor quality and low resolution of these satellite images hamper quality of map data generated using these image. To this end, high-resolution image data is required for improved feature extraction or for map generation processes.

In certain cases, probe devices, such as probe vehicles installed with imagery equipment may be used for collecting high-quality image data, such as high-resolution images of different regions. However, image data collected using these probe devices may be limited due to limited access of the probe devices, such as probe vehicles. For example, as the probe vehicles may only travel to areas having road connectivity, the image data may also be limited to such areas. In addition, using the probe devices for capturing the high-quality image data may be costly due to the use of high-precision and advanced sensors in the probe devices. As a result, the cost associated with the generation of the map data may increase.

### SUMMARY

The present disclosure provides a system for generating map data based on enhanced images, a method for training a neural network for generating enhanced images, and a computer programmable product for generating the map data based on enhanced images.

In one aspect, a system for generating map data based on enhanced images is provided. The system may include a memory configured to store computer executable instructions and one or more processors configured to execute the instructions to receive image data associated with a first image. The first image is associated with a first type. The first image is associated with a geographical region. The one or more processors are further configured to generate, using a first neural network, edge map data associated with the first image based on the image data. The one or more processors are further configured to generate, using a second neural network, a second image associated with the geographical region based on the edge map data. The second image may have a second type different from the first type. The second neural network is trained on a latent representation of each of a plurality of training images associated with a plurality of geographical regions. Each training image of the plurality of training images is associated with the second type. The one or more processors are further configured to generate, using a third neural network, a third image associated with the geographical region based on the second image. The third image may have a first resolution higher than a second resolution of the second image. The one or more processors are further configured to generate map data corresponding to the geographical region based on the third image.

In an embodiment, to train the second neural network, the one or more processors are further configured to receive the plurality of training images associated with the plurality of geographical regions. Each training image of the plurality of training images is associated with the second type. The one or more processors are further configured to generate, using the first neural network, training edge map data associated with each training image of the plurality of training images. The one or more processors may be further configured to re-generate, using the second neural network, a training second image corresponding to each training image of the plurality of training images based on the training edge map data and the plurality of training images. The one or more processors are further configured to generate, using the third neural network, a plurality of training third images based on the re-generated training second image corresponding to each training image of the plurality of training images and a high-resolution image corresponding each training image of the plurality of training images.

In an embodiment, to train the second neural network, the one or more processors are further configured to identify a set of training parameters associated with each training image of the plurality of training images. The one or more processors are further configured to re-generate, using the second neural network, the training second image corresponding to each training image of the plurality of training images based on the training edge map data and the set of training parameters.

In an embodiment, the set of training parameters associated with a training image of the plurality of training images comprises at least one of: a color, a gradient, or a spatial resolution.

In an embodiment, the first image is a low-resolution image of the first type. The second image is a low-resolution image of the second type.

In an embodiment, the first image is a satellite image.

In an embodiment, the one or more processors are further configured to receive, using the second neural network, the edge map data associated with the first image. The one or more processors may be further configured to determine, using the second neural network, a first set of parameters associated with the first image based on the image data. The one or more processors may be further configured to generate, using the second neural network, the second image associated with the geographical region based on the first set of parameters and the edge map data.

In an embodiment, the first neural network is a convolution neural network (CNN).

In an embodiment, the second neural network is a generative adversarial network (GAN).

In an embodiment, the third neural network is a diffusion model.

In an embodiment, the one or more processors are further configured to update the map data corresponding to the geographical region based on the third image.

In an embodiment, the one or more processors are further configured to receive a plurality of images associated with the plurality of geographical regions, the plurality of images being associated with the first type. Each of the plurality of images correspond to at least one geographical region from the plurality of geographical regions. The plurality of images comprises the first image. The one or more processors are further configured to generate a plurality of updated images corresponding to the plurality of geographical regions based on the plurality of images. The plurality of updated images comprise the third image associated with the geographical region. The one or more processors are further configured to train a plurality of machine learning (ML) models using the plurality of updated images. Each of the plurality of ML models are trained to generate one or more features of each of the plurality of geographical regions. The one or more processors are further configured to generate the map data based on the one or more features generated by the trained plurality of ML models.

In another aspect, a method for training a neural network for generating enhanced images is provided. The method may include receiving a plurality of training images associated with a plurality of geographical regions. Each training image of the plurality of training images is associated with a second type. The method may further include generating, using a first neural network, training edge map data associated with each training image of the plurality of training images. The method may further include training a second neural network to re-generate a training second image corresponding to each training image of the plurality of training images based on the training edge map data and the plurality of training images. The method may further include generating, using a third neural network, a plurality of training third images based on the re-generated training second image corresponding to each training image of the plurality of training images and a high-resolution image corresponding each training image of the plurality of training images.

In an embodiment, to train the second neural network, the method may further include identifying a set of training parameters associated with each training image of the plurality of training images. The method may further include training the second neural network to re-generate the training second image corresponding to each training image of the plurality of training images based on the training edge map data and the set of training parameters.

In an embodiment, the set of training parameters associated with a training image of the plurality of training images comprises at least one of: a color, a gradient, or a spatial resolution.

In an embodiment, the method may include receiving image data associated with a first image, the first image having a first type. The first image is associated with a geographical region. The method may further include generating, using the first neural network, edge map data associated with the first image based on the image data. The method may further include generating, using the second neural network, a second image associated with the geographical region based on the edge map data, the second image having a second type different from the first type. The second neural network is trained on a latent representation of each training image of the plurality of training images associated with the plurality of geographical regions. The method may further include generating, using the third neural network, a third image associated with the geographical region based on the second image, the third image having a first resolution higher than a second resolution of the second image. The method may further include generating map data corresponding to the geographical region based on the third image.

In an embodiment, the method may further include the first image is a low-resolution image of the first type. The second image is a low-resolution image of the second type.

In an embodiment, the method may further include updating the map data corresponding to the geographical region based on the third image.

In yet another aspect, a computer programmable product for generating the map data based on enhanced images is provided. The computer programmable product comprises a non-transitory computer readable medium having stored thereon computer executable instructions, which when executed by one or more processors, cause the one or more processors to carry out operations. The operations may include receiving image data associated with a first image, the first image having a first type. The first image is associated with a geographical region. The operations may further include generating, using a first neural network, edge map data associated with the first image based on the image data. The operations may further include generating, using a second neural network, a second image associated with the geographical region based on the edge map data, the second image having a second type different from the first type. The second neural network is trained on a latent representation of each of a plurality of training images associated with a plurality of geographical regions. Each training image of the plurality of training images is associated with the second type. The operations may further include generating, using a third neural network, a third image associated with the geographical region based on the second image, the third image having a first resolution higher than a second resolution of the second image. The operations may further include generating map data corresponding to the geographical region based on the third image.

In an embodiment, the operations may further include receiving the plurality of training images associated with the plurality of geographical regions. Each training image of the plurality of training images is associated with the second type. The operations may further include generating, using the first neural network, training edge map data associated with each training image of the plurality of training images. The operations may further include re-generating, using the second neural network, a training second image corresponding to each training image of the plurality of training images based on the training edge map data and the plurality of training images. The operations may further include generating, using the third neural network, a plurality of training third images based on the re-generated training second image corresponding to each training image of the plurality of training images and a high-resolution image corresponding each training image of the plurality of training images.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 illustrates a network environment in which a system for generating map data based on enhanced images is implemented, in accordance with an embodiment of the present disclosure;

FIG. 2 illustrates a block diagram of the system of FIG. 1, in accordance with an embodiment of the present disclosure;

FIG. 3 illustrates an exemplary flowchart of a method for generating an enhanced image using one or more neural networks, in accordance with an embodiment of the present disclosure;

FIG. 4 illustrates an exemplary block diagram of training the one or more neural networks, in accordance with an embodiment of the present disclosure;

FIG. 5 illustrates an exemplary block diagram of utilizing a first neural network, in accordance with an embodiment of the present disclosure;

FIG. 6 illustrates an exemplary block diagram of training a second neural network, in accordance with an embodiment of the present disclosure;

FIG. 7A illustrates exemplary operations for training an encoder model and decoder model associated with a third neural network, in accordance with an embodiment the present disclosure;

FIG. 7B illustrates exemplary operations for training the third neural network, in accordance with an embodiment the present disclosure;

FIG. 7C illustrates an exemplary operational diagram for training the third neural network to remove noise from enhanced images, in accordance with an embodiment of the present disclosure;

FIG. 8 illustrates an exemplary block diagram for generating the enhanced images utilizing the one or more neural networks, in accordance with an embodiment of the present disclosure;

FIG. 9A illustrates an exemplary flowchart of a method for generating navigational instructions using the map data, in accordance with an example embodiment the present disclosure;

FIG. 9B illustrates an exemplary flowchart of a method for training a plurality of machine learning (ML) models for generating the map data, in accordance with an embodiment of the present disclosure; and

FIG. 10 illustrates an exemplary flowchart of a method for generating the enhanced images, in accordance with an embodiment of the present disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification does not necessarily all refer to the same embodiment, nor are separate or alternative embodiments mutually exclusive of other embodiments. Further, the terms “a” and “an” herein do not denote a limitation of quantity but rather denote the presence of at least one of the referenced items. Moreover, various features are described which may be exhibited by some embodiments and not by others. Similarly, various requirements are described which may be requirements for some embodiments but not for other embodiments. As used herein, the terms “data,” “content,” “information,” and similar terms may be used interchangeably to refer to data capable of being displayed, transmitted, received, and/or stored in accordance with embodiments of the present disclosure. Thus, the use of any such terms should not be taken to limit the spirit and scope of embodiments of the present disclosure.

As defined herein, a “computer-readable storage medium,” which refers to a non-transitory physical storage medium (for example, a volatile or non-volatile memory device), may be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the description and should not be regarded as limiting. Any heading utilized within this description is for convenience only and has no legal or limiting effect.

### Definitions

The term “image” refers to a visual representation of data captured by an image sensor, which converts light signals into digital signals. The image may record original information captured by a digital camera sensor and metadata generated during the camera capturing. The original information may be, for example, resolution, sensor data, and the like. The metadata may be a setting of light sensitivity, a shutter speed, an aperture value, white balance, and the like. For example, the image may be captured by an image sensor of an electronic device mounted on, for example, a vehicle, a satellite, a handheld device, or the like.

In an example, a resolution may define the dimensions of an image in terms of width and height, expressed in pixels. For example, an image with a resolution of 4000×3000 pixels has a width of 4000 pixels and a height of 3000 pixels. In an example, an image may be a low-resolution image or a high-resolution image. The low-resolution image may be a satellite image. Further, the high-resolution image may be an image generated using probe devices, such as probe vehicles. The high-resolution image may have a higher number of pixels to represent the image than a low-resolution image. The higher the number of pixels of an image, the more detail and clarity may be present in the image. In an example, a high-resolution image may have a resolution of 8000×6000 pixels. In another example, a low-resolution image may have a resolution of 640×480 pixels.

Further, the term “image data” refers to data associated with an image. The image data may be associated with a first image. In an example, the first image may be the low-resolution satellite image. To this end, the data may include resolution, pixel values, color models (RGB (Red, Green, Blue), CMYK (Cyan, Magenta, Yellow, Black, HSV (Hue, Saturation, Value), LAB), metadata, annotations and labels, compression information, and the like.

In another example, the “image” may also be a digital image may be a visual representation that is encoded in a digital format, which can be processed, stored, and transmitted by electronic devices. It may be created using digital technology, such as digital cameras, scanners, or computer software, and is composed of pixels or data points that can be displayed on electronic screens or stored in digital files.

The term “type” may refer to a format of the image. Different types of images may have different formats. In an example, the different type of images may correspond to a first type, or a second type. In an example, the first type may be a satellite image format. In an example, the second type may be a high-resolution image format. In another example, the different type of images may be a raster image format such as JPEG (Joint Photographic Experts Group), PNG (Portable Network Graphics), GIF (Graphics Interchange Format), TIFF (Tagged Image File Format), BMP (Bitmap Image File), a Vector Image Format such as SVG (Scalable Vector Graphics, EPS (Encapsulated PostScript), PDF (Portable Document Format), a High Dynamic Range (HDR) format such as HDR (High Dynamic Range), EXR (Open EXR), and the like.

The term “neural network” may refer to a computational architecture consisting of a series of interconnected nodes (neurons) arranged in one or more layers which processes input data to produce output. The neural network is designed to recognize patterns, make decisions, and learn from experience by adjusting the connections between nodes based on the received input data. In an example, the neural network may be utilized in various applications, including but not limited to, image and speech recognition, natural language processing, and predictive analytics, enabling complex problem-solving through learned representations. In an example, the neural network may be a convolutional neural network (CNN) model, a generative adversarial Network (GAN) model, or a diffusion model.

The term “geographical region” may refer to a specific area of the Earth's surface that is defined by distinct physical characteristics. The geographical region may vary in size and may be identified based on natural features such as mountains, rivers, and climate, or by human-made boundaries like cities, states, or countries. The term geographical region is often used in fields such as navigation, resource management, and spatial analysis. Examples of geographical regions include forest areas, plains area, agricultural farmland, urban cities, etc. In an example, the geographical region may be a specific area on Earth's surface that is captured and analyzed through satellite-based remote sensing technology.

The term “map data” refers to data including traffic-related data, road topology and geometry-related data for a road network. In an example, the map data may also include cartographic data, routing data, and maneuvering data. Further, the map data may include lane and intersection data records or other data that may represent links in the route, pedestrian lane, or areas in addition to or instead of the vehicle lanes. The lanes and intersections may be associated with attributes, such as geographic coordinates, street names, lane identifiers, lane segment identifiers, lane traffic direction, address ranges, speed limits, turn restrictions at intersections, and other navigation-related attributes, as well as points of interest (POIs), such as fueling stations, hotels, restaurants, museums, stadiums, offices, auto repair shops, buildings, stores, and parks. The map data may additionally include data about places, such as cities, towns, or other communities, and other geographic features such as, but not limited to, bodies of water, and mountain ranges.

The term “edge map data” refers to data representing a visual representation (edge map) that highlights edges or boundaries within an image. In an example, the image may be associated with a building. The edge map data associated with the building may be a visual representation highlighting boundaries of the building. Further, the edge map may be generated during a detection process, a new image that describes each original pixel's edge classification and perhaps additional edge attributes, such as magnitude and orientation.

### End of Definitions

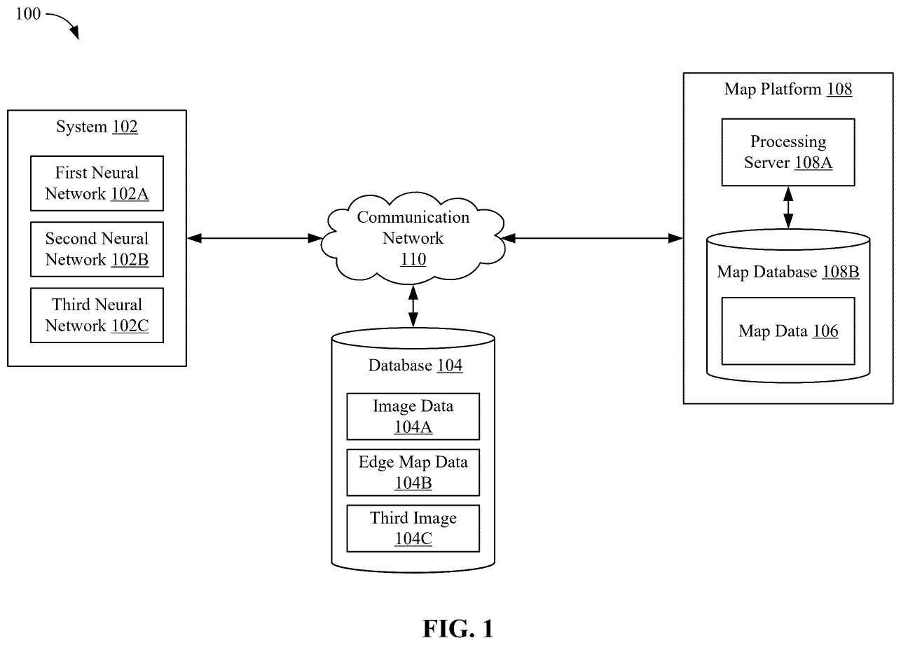

FIG. 1 illustrates a network environment 100 in which a system 102 for generating map data based on enhanced images is implemented, in accordance with an embodiment of the present disclosure. With reference to FIG. 1, the network environment 100 includes the system 102, a database 104, and a communication network 110. The system 102 further includes a first neural network 102A, a second neural network 102B, and a third neural network 102C. Further, it is possible that one or more components may be rearranged, changed, added, and/or removed without deviating from the scope of the present disclosure.

Map data are utilized in various mapping platforms for generating various navigational instructions. Typically, the map data are generated utilizing satellite images. Further, the map data are generated using feature points associated with the satellite images. In an example, the feature points may be distinct, recognizable points carrying significant information about the structure and content of the image. Feature points are often utilized to identify and describe key characteristics or patterns within an image. The satellite images are being utilized due to their high availability across all geographical regions. However, the satellite images being low-resolution images may affect the quality of the resultant map data. In certain cases, high-resolution images are utilized in the map data generation. The high-resolution images are being utilized as they provide better feature point detection used in the map making process. Use of the high-resolution images may generate a large number of feature points enhancing the efficacy of feature point detection. The high-resolution images are generated using probe devices, such as probe vehicles which are equipped with high-precision imagery equipment for collecting the high-resolution images. However, the probe vehicles have limited access to certain geographical regions. In an example, the probe vehicles may not have access to remote geographical regions and can only travel to areas having road connectivity. Limited access to geographical regions of the probe vehicles makes the high-resolution images scarcely available and for fewer geographical regions. Furthermore, the imagery equipment associated with the probe vehicles is of high cost making the high-resolution image costly in map data generation.

So, there is a need for converting low-resolution satellite images to high-resolution images. Image super resolution is a process of enhancing an image from a low resolution to a high resolution. This process utilizes deep learning models for converting the low-resolution images to the high-resolution images. Usually, a set of images from a same source is required for training these models.

Conventional models may not work when provided with images from different sources having different types or format. In an example, the conventional models may fail to accurately enhance low-resolution images of a particular type collected from a particular source into high-resolution images that closely correspond to images collected from a high-precision source. Further, the conventional models are not capable of style matching. Style matching refers to having similar visual style of the original image. For example, having same color gradient, saturation, and the like. In an example, the conventional models may not be capable of converting the low-resolution satellite image to the high-resolution images.

To overcome the aforementioned issues there is a need for converting the low-resolution satellite image to the high-resolution image for generating map data. The high-resolution image may correspond to an enhanced image. The present disclosure discloses the system 102 for generating enhanced images that may be used for map data generation. For example, the system 102 may convert a low-resolution satellite image to a high-resolution image.

The system 102 may include suitable logic, circuitry, interfaces, and/or code that may be configured to generate an enhanced image. Further, map data may be generated using the enhanced image. In an embodiment, the system 102 may be configured to generate a high-resolution image from a low-resolution satellite image utilizing one or more neural networks. The one or more neural networks may include the first neural network 102A, the second neural network 102B, and the third neural network 102C. Further, the system 102 may generate the map data from the generated high-resolution image, i.e., enhanced image. In certain cases, the system 102 may update the existing map data based on the generated high-resolution image, i.e., the enhanced image. In an example, the generated map data or the updated map data may be utilized in map content creation and maintenance and enhancement of the map database 108B.

In an example, the first neural network 102A may be implemented using, for example, a Convolutional Neural Network (CNN) model. The CNN model is a type of deep learning model specifically designed for processing structured grid data, such as images. CNN model may be predominantly used to extract the feature from the grid-like matrix dataset for example, visual datasets like images or videos where data patterns play an extensive role.

Further, the second neural network 102B may be implemented using, for example, a Generative Adversarial Network (GAN) model. The GAN model may be a type of machine learning model designed to generate new, synthetic data that resembles a given training dataset. GANs are a powerful class of neural networks that may be used for unsupervised learning.

Moreover, the third neural network 102C may be implemented using, for example, a diffusion model. The diffusion model is a type of generative model that simulates a process of data generation through a series of transformations, specifically by adding noise to data and then learning to reverse that process. This approach allows the model to generate new data samples that resemble the training dataset.

In an embodiment, the system 102 may be embodied in one or more of several ways as per the required implementation. For example, the system 102 may be embodied as a cloud-based service, a cloud-based application, a remote server-based service, a remote server-based application, a virtual computing system, a remote server platform or a cloud-based platform.

In an embodiment, the database 104 is configured to receive, store, and transmit data that may be collected from various sensors. In an embodiment, the database 104 may be configured to store at least one of image data 104A, edge map data 104B, and a third image 104C. Further, the image data 104A may be associated with a first image. The first image may correspond to an image of a geographical region under consideration.

In an example, the database 104 may also store training image data. The training image data may be a set of high-resolution images generated from probe devices, end user-vehicles, and the like. The vehicles may be a non-autonomous vehicle, a semi-autonomous vehicle, or a fully autonomous vehicle. For example, the system 102 is configured to generate enhanced images from the image data 104A of the first image. The enhanced image may be a high-resolution image that is similar to the set of high-resolution images in the training image data.

The map data 106 may be generated or updated by the system 102 based on the enhanced image(s) to be utilized in map content creation. In accordance with an embodiment, the map database 108B may be configured to receive the map data 106 including the road topology and geometry-related attributes related to the road network from the system 102.

All the components in the network environment 100 may be coupled directly or indirectly to the communication network 110. The components described in the environment 100 may be further broken down into more than one component and/or combined together in any suitable arrangement. Further, one or more components may be rearranged, changed, added, and/or removed.

In an example, the system 102 may be coupled with the mapping platform 108 via the communication network 110. The mapping platform 108 may comprise suitable logic, circuitry, and interfaces that may be configured to store the map data 106 generated by the system 102. The mapping platform 108 may be configured to store and update the map data 106 indicating the traffic data along with other map attributes, road attributes, and traffic entities, in the map database 108B.

Continuing further, the mapping platform 108 may include the processing server 108A for carrying out the processing functions associated with the mapping platform 108 and the map database 108B for storing the map data 106 and other information. Further, the map database 108B may comprise suitable logic, circuitry, and interfaces that may be configured to store the map data 106.

In operation, the system 102 is configured to receive the image data 104A associated with the first image. The first image may have the first type. In an example, the first type corresponds to a low-resolution image type that may be gathered by a satellite, i.e., a low-resolution satellite image. Specifically, the first type may be the format associated with the low-resolution satellite image. The image data 104A may be received from the database 104. Further, the first image is associated with the geographical region. In an example, the geographical region may be a forest area, an urban area, a water body, and the like.

Further, the system 102 is configured to generate edge map data 104B. The edge map data 104B is generated using the first neural network 102A. The edge map data 104B is associated with the first image. The system 102 may apply the first neural network 102A on the first image associated with the geographical region to generate the edge map data 104B. In an example, the edge map data 104B may be a visual representation that highlights edges or boundaries within the first image. Specifically, the edge map data 104B of the first image may indicate where edges or boundaries are present in the first image. In an example, if the first image corresponds to an urban area, the edge map data may indicate edges of various structures, such as buildings, towers, industries, etc. present in the urban area. Alternatively, if the first image corresponds to a forest area, the edge map data may indicate edges of various structures, such as mountains, trees, open areas, water body, etc. within the forest area.

The system 102 is configured to generate a second image using the second neural network 102B based on the edge map data 104B. The system 102 may receive the edge map data 104B from the first neural network 102A. The second image is associated with the geographical region. The second image may have a second type different from the first type of the first image. For example, the second type may correspond to a different format of images. As may be noted, the first type corresponds to low-resolution satellite images, the second type is different from the first type. The second type corresponds to a format of image that is collected by probe vehicles.

In this regard, the system 102 is configured to apply the second neural network 102B on the image data 104A and the edge map data 104B to generate the second image. Specifically, the second image is a low-resolution image of the second type. The second neural network 102B is trained on a latent representation of each of a plurality of training images associated with a plurality of geographical regions. In an example, the latent representation may be an abstract, compressed form of an image that captures its essential features or characteristics. In an example, the latent representation may correspond to the edge map data of the plurality of training images. Further, the plurality of training images is associated with the second type. Each training image of the plurality of training image have the second type different from the first type associated with the first image.

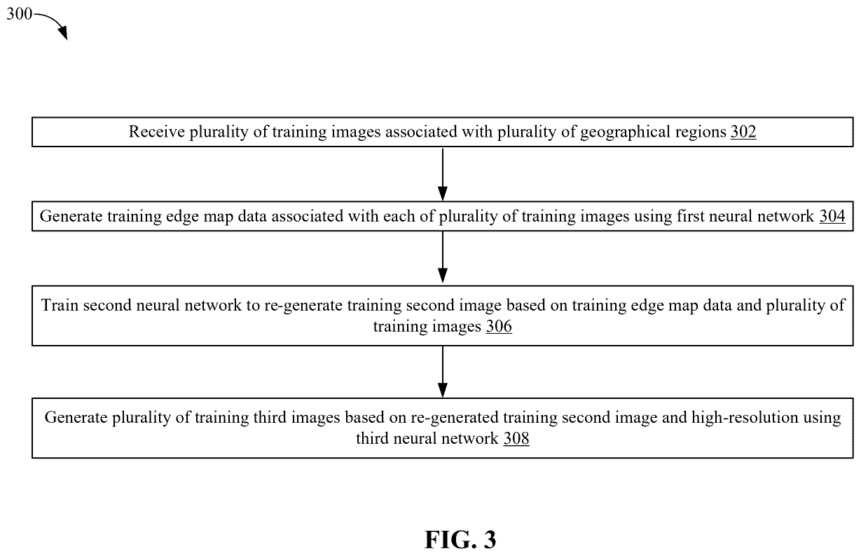

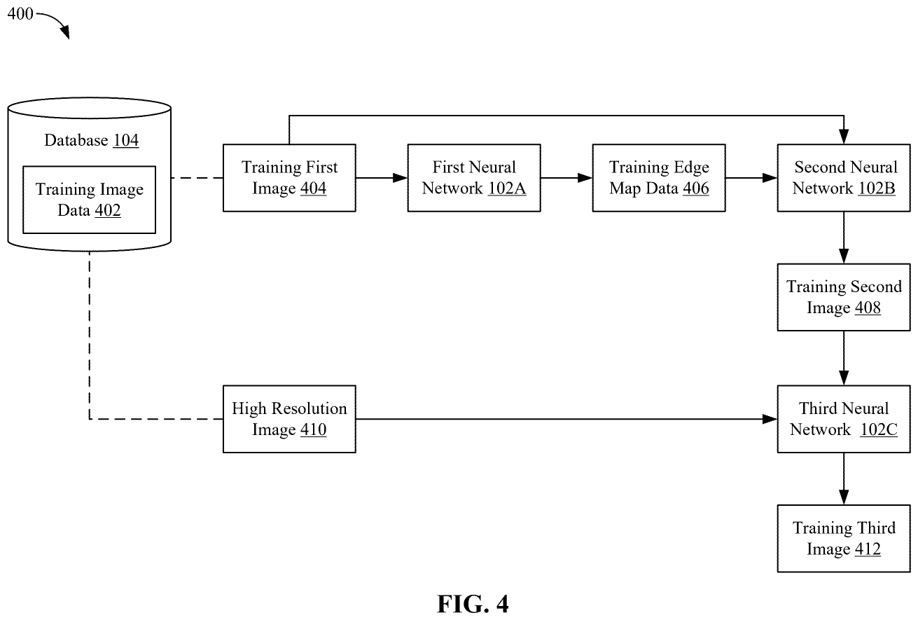

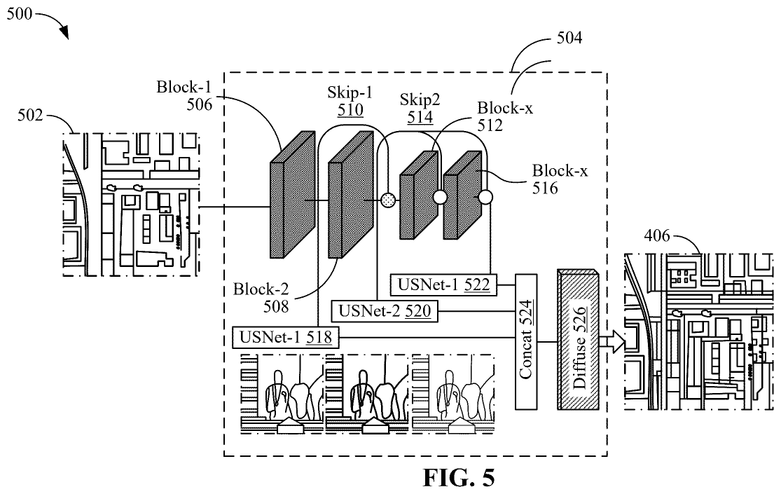

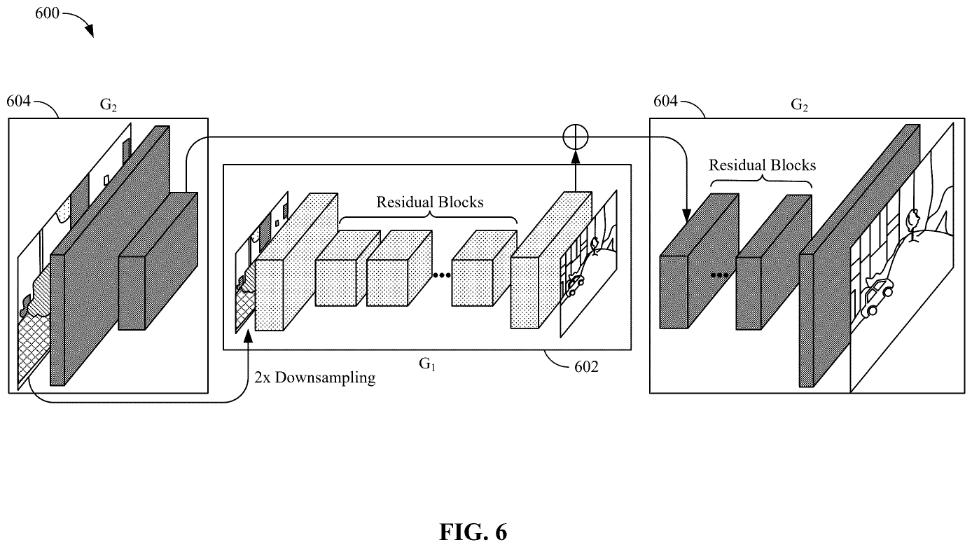

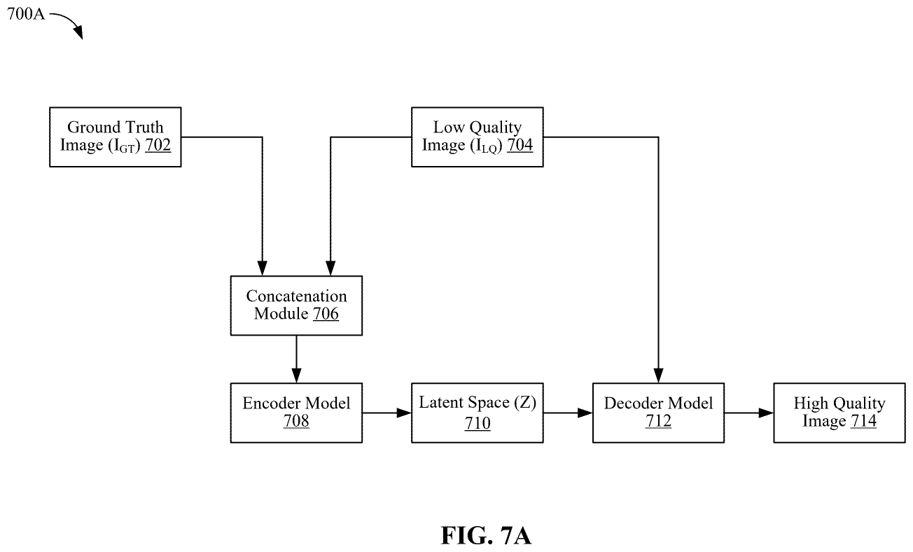

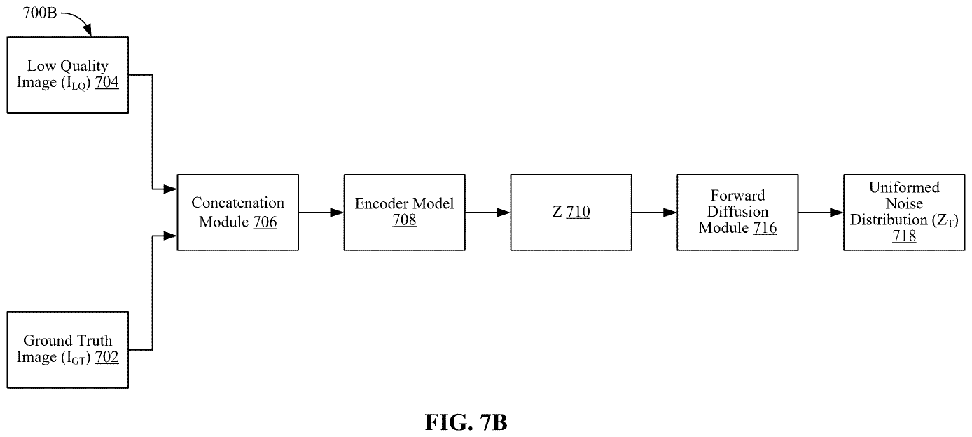

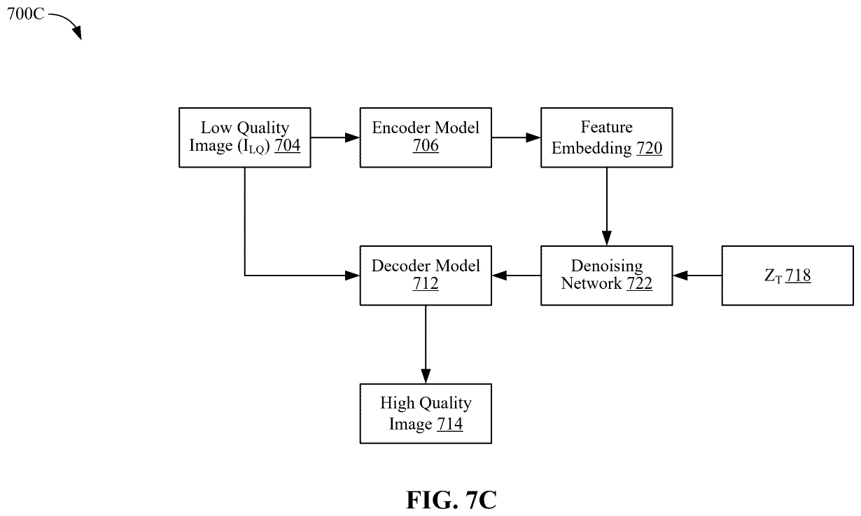

In an example, the one or more neural networks may be trained on the plurality of training images. The first neural network 102A may generate training edge map data associated with each training image of the plurality of training images. Further, the second neural network 102B may be trained on the training edge map data associated with each of the plurality of training images to re-generate a training second image corresponding to each of the plurality of training images. Furthermore, the third neural network 102C may be trained on the re-generated training second image corresponding to each of the plurality of training images and a high-resolution image corresponding each of the plurality of training images to generate a plurality of training third images. Each training third image of the plurality of training third images may have a format comparable to a high-resolution image of the second type. Details of the operations for the training of the one or more neural networks are provided in conjunction with, for example, FIG. 3, FIG. 4, FIG. 5, FIG. 6, FIG. 7A, FIG. 7B, and FIG. 7C.

Further, the system 102 is configured to generate a third image 104C using the third neural network 102C. The third image 104C is generated based on the second image. The third image 104C may have a first resolution. The first resolution is higher than a second resolution of the second image. It may be noted that the third image 104C also corresponds to the second type, such as a format of the images captured using probe devices or vehicles.

In an example, the third image 104C may be an image having the format comparable to the high-resolution probe images. The third image 104C is associated with the geographical region. In an embodiment, the third neural network 102C may be the diffusion model. The diffusion model may generate the third image 104C based on the second image. By way of an example and not limitation, the system 102 may generate the third image 104C having a resolution of “1920×1080 pixels” which is higher or greater than a resolution of “640×640 pixels” of the second image. Further, the details of the operations of the third neural network 102C is described in conjunction with, for example, FIG. 7A, FIG. 7B, and FIG. 7C.

At the end, the system 102 is configured to output the third image 104C of the geographical region. In an example, the third image 104C may be used for downstream processing or tasks, such as map data generation, map data update, generation of navigation instructions, etc.

In an example, the system 102 may be configured to update the map data 106 based on the third image 104C. For example, a part of the map data 106 corresponding to the geographical region may be generated or updated based on the third image 104C. In an example, the generated map data 106 may be used to generate and provide navigation instructions. The navigational instruction may indicate a navigation route for a vehicle. As a result, the generated navigation instructions may ensure efficient and safe navigation for the vehicle through the geographic region.

These and other embodiments of the present disclosure are explained in further detail in conjunction with the following figures.

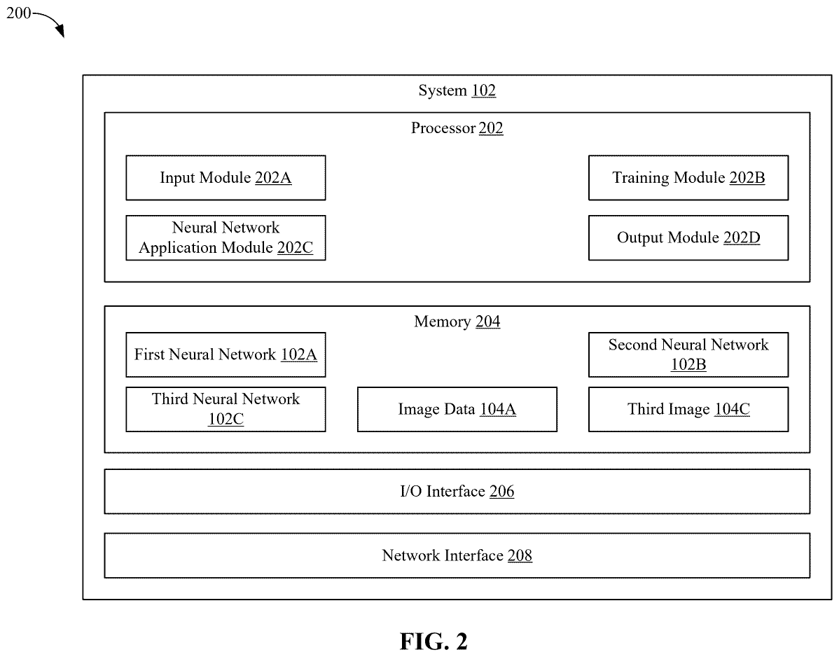

FIG. 2 illustrates a block diagram 200 of the system 102 of FIG. 1, in accordance with an embodiment of the present disclosure. FIG. 2 is explained in conjunction with elements of FIG. 1.

The system 102 comprises a processor 202, a memory 204, an Input/Output (I/O) interface 206, and a network interface 208. The processor 202 may be connected to the memory 204, the I/O interface 206, and the network interface 208 through one or more wired or wireless connections. Further, the processor may include modules, such as an input module 202A, a training module 202B, a neural network application module 202C, and an output module 202D Although in FIG. 2, it is shown that the system 102 includes the processor 202, the memory 204, the I/O interface 206, and the network interface 208, however, the disclosure may not be so limiting and the system 102 may include fewer or more components to perform the same or other functions of the system 102.

In accordance with an embodiment, the system 102 may store data that may be generated by the modules while performing corresponding operations or may be retrieved from the database 104 associated with the system 102. The data may include, for example, the image data 104A of the first image, and the third image 104C, that is an enhanced version of the first image.

The system 102 may be configured to perform the image super-resolution with style matching. The processor 202 of the system 102 may be configured to convert the low-resolution satellite images to an enhanced images of a second type that corresponds to high-quality probe images. Further, the processor may be configured to utilize the high-resolution image to generate the map data 106.

The input module 202A of the processor 202 may be configured to obtain the image data 104A. The image data 104A may be associated with the first image, such that the first image corresponds to a first type. In an example, the image data 104A may be associated with a low-resolution satellite image, such that the first type corresponds to a format of satellite imagery. The input module 202A may receive the image data 104A from the memory 204, and/or any other data repositories available over the communication network 110. In certain cases, the input module 202A may also receive the plurality of training images. The plurality of training images may be utilized to train the one or more neural networks. In an example, the plurality of training images may be captured from connected-car sensors, smartphones, personal navigation devices, fixed road sensors, smart-enabled commercial vehicles, and expert monitors observing geographical regions.

The training module 202B of the processor 202 may be configured to train the one or more neural networks based on the plurality of training images. The one or more neural networks may be trained to generate the third image 104C further utilized in generating the map data 106. In an embodiment, the one or more neural networks may be trained to identify a relationship between a set of inputs, such as a set of features in a training dataset, and output predictive values. The one or more models may include the first neural network 102A, the second neural network 102B, and the third neural network 102C.

The one or more neural networks may be trained on the plurality of training images to generate the first image, the second image, and, finally, the third image 104C during the inference phase of the one or more neural networks. In an embodiment, the first neural network 102A may be trained to generate the edge map data 104B associated with the first image. In an embodiment, the second neural network 102B may be trained to generate the second image associated with the geographical region based on the edge map data 104B. In an embodiment, the third neural network 102C may be trained to generate the third image 104C associated with the geographical region. Details about the training of the one or more neural networks are further provided, for example, in FIG. 7B.

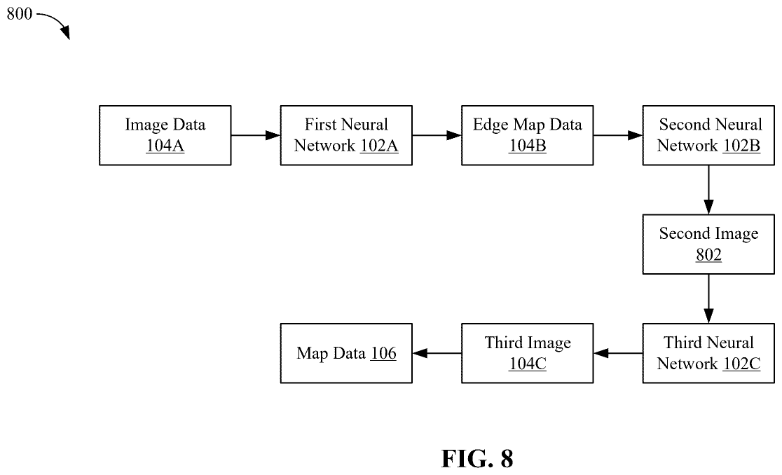

The neural network application module 202C of the processor 202 may be configured to apply the one or more neural networks to a plurality of inputs. The plurality of inputs may include the first image, the edge map data 104B, and the second image. The one or more neural networks may be applied on the image data 104A of the first image to generate the edge map data 104B, the second image, and the third image 104C. In an embodiment, the first neural network 102A may be applied on the image data 104A to generate the edge map data 104B associated with the first image. In an embodiment, the second neural network 102B may be applied on the edge map data 104B to generate the second image associated with the geographical region. In an embodiment, the third neural network 102C may be applied to the second image to generate the third image 104C associated with the geographical region. Details about the implementation of the one or more neural networks are provided, for example, in FIG. 3 and FIG. 8.

Each of the one or more neural networks (such as, the first neural network 102A, the second neural network 102B, and the third neural network 102C) may include electronic data, such as, for example, a software program, code of the software program, libraries, applications, scripts, or other logic or instructions for execution by a processing device, such as the system 102. The one or more neural networks may include code and routines configured to enable a computing device, such as the system 102 to perform one or more operations associated with the generation of an enhanced image, i.e., the third image 104C of the geographical region.

Additionally, or alternatively, the one or more neural networks may be implemented using hardware including a processor, a microprocessor (e.g., to perform or control the performance of one or more operations), a field-programmable gate array (FPGA), or an application-specific integrated circuit (ASIC). Alternatively, in some embodiments, the one or more neural networks may be implemented using a combination of hardware and software.

The output module 202D may be configured to output the map data 106 generated using the one or more neural networks. In an embodiment, the output module 202D may be configured to output the third image 104C. In an example, the output module 202D may cause rendering of the third image 104C on a display. In another example, the output module 202D may provide the third image 104C for downstream processing, such as for map data generation, navigation instructions generation, map feature extraction, training of downstream ML models associated with map data and navigations.

The memory 204 of the system 102 may be configured to store at least the image data 104A of the first image, the edge map data 104B, the second image, and the third image 104C. The second image may be the low-resolution image of the second type. In an embodiment, the memory 204 may be configured to store the first neural network 102A, the second neural network 102B, and the third neural network 102C.

In some example embodiments, the I/O interface 206 may communicate with the system 102 and display the input and/or output of the system 102. In an example, the I/O interface 206 may provide outputs for an end user to view the third image 104C as well as the map data 106.

In an exemplary embodiment, the I/O interface 206 may present information relating to map data for the particular geographical region. Thereafter, based on the map data 106 the map database 108B may be updated. It is further noted that the I/O interface 206 may operate over the communication network 110 to facilitate the exchange of information.

FIG. 3 illustrates an exemplary flowchart 300 of a method for generating an enhanced image using one or more neural networks, in accordance with an embodiment of the present disclosure. FIG. 3 is explained in conjunction with elements of FIG. 1 and FIG. 2. The one or more neural networks may include the first neural network 102A, the second neural network 102B and the third neural network 102C.

At 302, a plurality of training images is received. In an embodiment, the system 102 may be configured to receive the plurality of training images associated with a plurality of geographical regions. Each training image of the plurality of training images is associated with the first type. Each training image of the plurality of training images may be low-resolution image of the first type, such as the format corresponding to satellite images gathered using satellites. In an example, the plurality of training images may be received from the database 104. The processor 202 may be configured to receive the plurality of training images and transfer the plurality of training images to the first neural network 102A.

At 304, training edge map data is generated. In an embodiment, the system 102 may be configured to generate the training edge map data associated with each training image of the plurality of training images using the first neural network 102A. The first neural network 102A may receive each of the plurality of training images and apply one or more process on each of the plurality of training images. In an example, the first neural network 102A may be the CNN model. Further, the CNN model may be a light-weight pre-trained model. The lightweight pre-trained model refers to a machine learning or deep learning model that has been pre-trained on a large dataset and is designed to be smaller and more efficient in terms of computational resources. The CNN model may be optimized to have a smaller file size, allowing for faster loading and inference times.

In an example, the CNN model may receive the plurality of training images and generate the training edge map data. The CNN model may be trained to extract object contours and the most prominent visual edges from each training images of the plurality of training images. Further, the CNN model is trained to apply the one or more process on each training image of the plurality of training images to generate the training edge map data. The training edge map data may be a visual representation that highlights the edges or boundaries within an image. Further, the processor 202 may transfer the training edge map data to the second neural network 102B. Furthermore, the details of the operations of the first neural network 102A is provided, for example, in the FIG. 5.

At 306, the second neural network 102B is trained. In an embodiment, the system 102 may be configured to train the second neural network 102B. The second neural network 102B is trained to re-generate a training second image corresponding to each training image of the plurality of training images based on the training edge map data and the plurality of training images. The second neural network 102B may receive the training edge map data associated with each training image of the plurality of training images from the first neural network 102A. Further, the second neural network 102B may be trained to generate a training second image corresponding to each training image of the plurality of training images, thereby performing a re-generation operation for the plurality of training images.

In an embodiment, the second neural network 102B may receive training edge map data associated with a training image of the plurality of training images from the first neural network 102A. Further, the second neural network 102B may receive the training image under consideration. The second neural network 102B may be trained to utilize the training image of and the training edge map data to generate a training second image corresponding to the training image. In an example, the training second image may be of the second type. Further, the training second image may be low-resolution image of the second type having the format comparable to images captured by probe devices or equipment. In an example, the second neural network 102B may be a GAN model. Further, the training of the GAN model is described, for example, in the FIG. 6.

The GAN model may generate new, synthetic data that resembles the training image. The GAN model may be trained to re-generate the training second image corresponding to a type that may be similar to the second type associated with the plurality of the training images on which it is trained.

At 308, a plurality of training third images is generated. In an embodiment, the system 102 may be configured to generate the plurality of training third images using a third neural network 102C. The plurality of training third images are generated based on the re-generated training second images corresponding to the plurality of training images and a high-resolution image corresponding to each training image of the plurality of training images. The third neural network 102C may receive the re-generated training second image corresponding to each training image of the plurality of training images from the second neural network 102B. Further, the third neural network 102C may receive the high-resolution image corresponding to each training image of the plurality of training images from the database 104. In an example, the third neural network 102C may be the diffusion model. The training third image corresponds to a type similar to the second type of the training second image.

In an embodiment, during the inference phase of the one or more neural networks, the system 102 may utilize the trained one or more neural network to generate an enhanced image (referred to as a third image) of a geographic region 106. The first neural network 102A may generate the edge map data 104B based on the image data 104A associated with the first image. Further, the second neural network 102B may generate the second image based on the edge map data 104B. Furthermore, the third neural network 102C may generate the third image 104C based on the second image. Further, the operations of the inference phase of the one or more neural networks is explained in FIG. 1 and FIG. 8.

FIG. 4 illustrates an exemplary block diagram 400 for training the one or more neural networks, in accordance with an example embodiment of the present disclosure. FIG. 4 is explained in conjunction with elements of FIG. 1, FIG. 2, and FIG. 3.

In an embodiment, the system 102 may be configured to train the one or more neural networks to generate the enhanced image. The one or more neural networks may be trained based on various parameters to generate the enhanced image. Further, for the training of the one or more neural networks the processor 202 may be configured to receive training image data 402 of a plurality of training images from the database 104. The training image data may be associated with each of the plurality of training images. The training image data 402 may comprise a training first image 404 and a high-resolution image 410. The training first image 404 may correspond to a training image of the plurality of training images. The training first image 404 may be a low-resolution image of the first type. Further, the high-resolution image 410 may correspond to the training first image 404 and also be associated with the first type. For example, the training first image 404 and the high-resolution image 410 may be images of the first type of an area. However, the training first image 404 may be of low-resolution, while the high-resolution image 410 may be of high-resolution. As may be noted, the first type may correspond to a format of image that may be captured using satellites. Furthermore, the training first image 404 may be fed to the first neural network 102A.

The first neural network 102A may be a pretrained neural network for performing the one or more operations like convolution, pooling, and the like. In an embodiment, the fist neural network 102A may be implemented using CNN for performing the one or more operations. The first neural network 102A may receive the training first image 404 and apply one or more process on the training first image 404.

In an exemplary embodiment, the CNN model may receive the training first image 404. The CNN model may extract object contours and the most prominent visual edges from the training first image 404. Further, the CNN model may extract edge features from the training first image 404 by applying different filters to the training first image 404. The CNN model may identify edges, lines, curves, and other features from the training first image 404. The CNN model may generate training edge map data 406 based on the training first image 404. The training edge map data 406 may be a visual representation that highlights the edges or boundaries within the training first image 404. Further, the generated training edge map data 406 may be fed to the second neural network 102B for training thereof.

The second neural network 102B may be implemented using the GAN model. The second neural network 102B may receive the training first image 404 and the training edge map data 406. The second neural network 102B may receive the training edge map data 406 from the first neural network 102A. The second neural network 102B may receive the training first image 404 from the database 104. The second neural network 102B may be trained based on the training first image 404 and the training edge map data 406. In an exemplary embodiment, the second neural network 102B may be trained to identify a first set of parameters from the training first image 404 and apply those parameters on the training edge map data 406. This may be done to maintain a same format which may correspond to the first type of the training first image 404.

In an example, the second neural network 102B may be trained to perform a domain transfer operation. The GAN model may be trained to generate new, synthetic data that may resemble the training first image 404. The GAN model may be trained based on the received training edge map data 406 and the training first image 404. Further, the GAN model may be configured to generate the training second image 408 based on the training edge map data 406. The training second image 408 may have a third type similar to the first type of the training first image 404. Furthermore, the training second image 408 may be fed to the third neural network 102C.

The third neural network 102C may be the diffusion model. The third neural network 102C may receive the high-resolution image 410 and the training second image 408. The third neural network 102C may receive the training second image 408 from the second neural network 102B. The third neural network 102C may receive the high-resolution image 410 from the database 104. The third neural network 102C may be trained based on the high-resolution image 410 and the training edge map data 406. The third neural network may generate the training third image 412 based on the training second image 408 and the high-resolution image 410.

In an exemplary embodiment, the third neural network 102C may be the diffusion model trained to increase the resolution of the training second image 408 to generate the training third image 412. The third neural network 102C may be trained to increase the resolution of the training second image 408 from a first resolution value to a second resolution value. The second resolution value may be associated with the high-resolution image 410.

Further, all the operations performed by the one or more neural networks may be performed for each of the plurality of training image data for training of each of the first neural network 102A, the second neural network 102B, and the third neural network 102C.

FIG. 5 illustrates an exemplary block diagram 500 for utilizing the first neural network 102A, in accordance with an example embodiment of the present disclosure. With reference to FIG. 5, there is shown a CNN model 504. The CNN model 504 may include a plurality of layers. The plurality of layers may include a block-1 506, a block-2 508, a skip-1 510, a block-x 512, a skip-2 514, and a block-x 516. Further, the CNN model 504 may include a set of U-shaped networks (USNet), a concat, and a diffuse. Furthermore, the set of USNet may include a USNet-1 518, a USNet-2 520, and a USNet-3 522. FIG. 5 is explained in conjunction with elements of FIG. 4. Although illustrated with discrete blocks, the exemplary operations associated with one or more blocks of the block diagram 500 may be divided into additional blocks, combined into fewer blocks, or eliminated, depending on the particular implementation.

In an embodiment, the first neural network 102A, i.e., the CNN 504, may be configured to generate the training edge map data 406. The training edge map data 406 may be associated with a training first image 502 of the plurality of training images. Further, for generating training edge map data 406, the system 102 may be configured to receive the training first image 502. The training first image 502 may correspond to the training first image 404 of the plurality of training images. The training first image 502 may correspond to the first type. Further, the training first image 502 may correspond to a geographical region from the plurality of geographical region. In an example, the system 102 may receive the training first image 502 from the database 104. The CNN 504 may generate the training edge map data 406 based on the training first image 502. The system 102 may feed the training edge map data 406 to the second neural network 102B.

The block-1 506 of the CNN model 504 may be configured to extract low-level features such as edges, textures, or simple patterns from the training first image 502. The block-1 506 may utilize a plurality of layers for processing the training first image 502. In an example, each layer of the plurality of layers may include convolution layers, an activation layer, a normalization layer, and a pooling layer. The block-1 506 may utilize the plurality of layers to extract a first set of features corresponding to the low-level features from the training first image 502.

In an example, the convolutional layer may utilize a set of learnable filters or kernels to detect low-level features such as edges, textures, or simple patterns. The output from the convolutional layers may be passed through the activation layer, for example, a Rectified Linear Unit (ReLU). The activation layer may introduce non-linearity into the model, allowing it to learn and represent complex patterns and relationships in the data. In some implementations, the system 102 may further utilize the normalization layer, such as batch normalization. Batch normalization helps to stabilize and accelerate the training process. Further, block-1 506 may also incorporate the pooling layer, such as Max Pooling. The Pooling layer may reduce the spatial dimensions of the feature maps, effectively down sampling the data and focusing on the most significant features. This reduction helps decrease computational complexity. Furthermore, the output of the pooling layer may be fed to the block-2 508.

The block-2 508 may be configured to extract more complex features and patterns. The block-2 508 may utilize one or more layers similar to the plurality of layers for processing the first set of features extracted by the block-1 506. In an example, the layers may include convolution layers, an activation layer, a normalization layer, and a pooling layer. The block-2 508 may utilize this plurality of layers to extract a second set of features corresponding to the more complex features and the patterns. The block-2 508 may transfer the second set of features to the block-x 512. Further, the block-2 508 may transfer the second set of features to the USNet-1 518 using the skip-1 510. The skip-1 510 may be configured to connect the output of the block-2 508 to the USNet-1 518, thereby enabling the USNet-1 518 to use the second set of features from the block-2 508.

The block-x 512, may be configured to extract high-level features. The block-x 512 may receive the second set of features from the block-2 508. The block-x 512 may utilize the one or more layers to generate a third set of features. The third set of features may correspond to the high-level features. The block-2 508 may transfer the third set of features to the block-x 512. Further, the block-x 512 may transfer the third set of features to a USNet-2 using the skip-2 514. The skip-2 514 may be configured to connect the output of the block-x 512 to the USNet-2 520, thereby enabling the USNet-2 520 to use the third set of features from the block-x 512.

The block-x 516 may extract a refined set of features from the third set of features. The block-x 516 may receive the third set of features from the block-x 516. The block-x 516 may transfer the refined set of features to a USNet-3 522. Further, the block-x 516 may transfer the refined set of features to the USNet-2 520 using the skip-2 514.

The USNet-1 518 may be a decoder module employing specific convolutional operations to generate a set of feature maps. The USNet-1 518 may receive the first set of features from Block-1 506 and process them using convolutional operations. In an example, The USNet-1 may utilize a 1×1 convolutional layer, configured to perform dimensionality reduction and feature re-weighting by applying filters across individual pixel positions, and optimizing feature channels without altering spatial dimensions. Further, USNet-1 518 may incorporate a 2×2 convolutional layer with a stride of 2, known as a 2×2 strided convolution. The 2×2 convolution layer may downscale the output of the 1×1 convolution layer reducing spatial dimensions and capturing broader contextual features. Further, the USNet-1 518 may transfer the set of feature maps to the concat module 524.

The USNet-2 520 may be a decoder module similar to the USNet-1 518 employing specific convolutional operations for generating high-level feature maps. The USNet-2 520 may receive a set of inputs including the third set of features from the block-x 512 and the refined set of features from the block-x 516 and process it using the 1×1 convolution layer and 2×2 convolution layer. The USNet-2 520 may employ the 1×1 convolution layer and the 2×2 convolution layer for processing the set of inputs. Further, the USNet-2 520 may transfer the high-level feature maps to the concat module 524.

The USNet-3 522 may be a specialized decoder module configured to receive and process the refined set of features from Block-x 516. Upon receiving the refined set of features, USNet-3 522 may undertake a series of convolutional operations designed to further enhance the refined set of features. Initially, USNet-3 522 applies a 1×1 convolutional layer with 16 filters, which serves to perform dimensionality reduction and feature re-weighting by transforming the feature channels while maintaining the spatial dimensions. Further, a 4×4 convolutional layer with a stride of 2 may be employed, to perform down sampling for capturing broader contextual features and reducing spatial dimensions. Subsequently, a 1×1 convolutional layer with 1 filter may be employed to perform final dimensionality adjustment and feature re-weighting. Finally, a 4×4 convolutional layer with a stride of 2 may be applied to further downscale the feature maps while preserving and refining contextual details.

Further, output corresponding to each of the USNet-1 518, the USNet-2 520, and the USNet-3 522, may be fed to the concat module 524. The concat module 524 may combine features from different layers or blocks. The concat module 524 may perform a concatenation operation. The concat module 524 may integrate the feature maps from USNet-1 518, USNet-2 520, and USNet-3 522 into a unified set of feature maps. The concat module 524 may combine the distinct feature representations from each of the set of USNet modules into the unified set of feature maps. The resulting unified set of feature maps preserves the spatial dimensions and combines the diverse features extracted at various stages of the network, enabling a comprehensive representation of the training first image 502. The unified set of feature maps may be fed to the diffuse model 526.

The diffuse model 526 may be configured to receive the unified set of feature maps from the concat module 524. The diffuse model 526 may perform a series of operations for further processing and refining the unified set of feature maps. The diffuse model 526 may apply advanced convolutional techniques to distribute and smooth the unified set of features, ensuring that the integrated information from the concat module 524 is effectively utilized. The series of operations involves operations such as additional convolutions, normalization, and activation functions to enhance feature representation and maintain spatial coherence. The output of the diffuse model 526 may be a set of refined feature maps that embody the comprehensive and detailed information from the concatenated inputs, optimized for subsequent stages of processing or final output generation. In an example, the set of the refined feature maps may be utilized for creating the training edge map data 406.

FIG. 6 illustrates an exemplary block diagram 600 of training the second neural network 102B, in accordance with an example embodiment of the present disclosure. FIG. 6 is explained in conjunction with elements of FIG. 1, FIG. 2, FIG. 3, FIG. 4 and FIG. 5.

In an embodiment, the system 102 may be configured to train the second neural network 102B. The second neural network 102B may be the GAN model. The GAN model is trained on the training edge map data 406 and the plurality of training images to learn reconstruction of images from the training edge map data 406 to an original plurality of training images. Further, for training the second neural network 102B, the system 102 may be configured to receive the plurality of training images and the training edge map data associated with each training image of the plurality of training images. The plurality of training images may correspond to the first type. Further, the plurality of training images may correspond to a plurality of geographical regions. In an example, the system 102 may receive the training edge map data 406 from the first neural network 102A. The system 102 may feed the training edge map data 406 to the second neural network 102B.

The GAN model may include a first residual network (G1) 602 and a second residual network (G2) 604. The first residual network 602 is referred to as G1 602, hereinafter. The second residual network 604 is referred to as G2 604, hereinafter. The system 102 may be configured to train both G1 602 and G2 604 to generate the training second image 408. The training second image 408 may be similar to the training first image 404, i.e., may correspond to the first type.

In an embodiment, the G1 602 may have a deep learning architecture. The G1 602 comprises a plurality of residual blocks. The G1 602 may utilize skip connections. Skip connections connect activations of a layer to further layers by skipping some layers in between forming a residual block. G1 602 may be made by stacking these residual blocks together. The residual network is further trained on the plurality of training images. In an embodiment, the residual network may be trained to generate one or more feature maps. The G1 602 is the initial stage of the GAN model, designed to process low-resolution images. G1 602 may include multiple residual blocks, where each block contains a series of convolutional layers and a shortcut connection. The shortcut connection allows the network to learn residuals, or differences, between the input and the desired output. During training, G1 602 may learn to extract relevant features from the low-resolution image, which are then represented as the one or more feature maps. These feature maps capture details of the images and provide foundational information for subsequent processing.

Further, the G2 604 may be appended to G1 602. The G2 604 may also have a deep learning architecture. The G2 604 may be another set of residual blocks added to the architecture. The G2 604 may receive the training edge map data 406 from the CNN model as an input. The G2 604 may be configured to refine and enhance the one or more features extracted by G1 602, focusing on high-resolution details. The G2 604 may be appended to G1 602 to jointly train G2 604 and G1 602.

In an embodiment, during the joint training of the G1 602 and the G2 604, the G2 604 may process one or more feature maps produced by the G1 602. Further, the input to the residual blocks in G2 604 may be the element-wise sum of the feature maps from G1 602 and the output features from G2 604. This combined feature map may be used by G2 604 to produce the final processed output.

In an embodiment, the system 102 may be configured to identify a set of training parameters associated with each training image of the plurality of training images. The system 102 may identify the set of parameters utilizing the second neural network 102B. The set of training parameters associated with a training image of the plurality of training images comprises at least a color, a gradient, or a spatial resolution. The gradient may provide information about how pixel values vary spatially within an image. The special resolution may describe the amount of detail an image holds. The special resolution is determined by the number of pixels used to represent the image and the size of each pixel. Higher spatial resolution means more pixels are used, which allows the image to capture finer details and produce a clearer picture.

In an example, the G1 602 is initially trained to extract a set of features from the plurality of training images having low-resolution. The G1 602 may learn to encode important details and patterns from these images into feature maps. This phase focuses solely on processing the low-resolution image to produce useful feature representations.

In an embodiment, the system 102 may be configured to re-generate, using the second neural network 102B, the training second image corresponding to each training image of the plurality of training images based on the training edge map data 406 and the set of training parameters. In an example, during the joint training of G1 602 and the G2 604, the set of parameters may be identified and applied on the training edge map data 406.

In an example, during the joint training, G2 604 applies the set of parameters to the training edge map data 406. The training edge map data 406 may provide additional context about the structural details and boundaries in the images. The G2 604 may utilize this information to refine and enhance the features produced by G1 602, and further produce the training second images for the plurality of training images. These training second images may be of the first type and have low-resolution.

FIG. 7A illustrates exemplary operations 700A for training an encoder model 708 and a decoder model 712 associated with the third neural network 102C, in accordance with an example embodiment of the present disclosure. FIG. 7A is explained in conjunction with elements of FIG. 1, FIG. 2, FIG. 3, FIG. 4, FIG. 5, and FIG. 6.

In an embodiment, the system 102 may be configured to train the encoder model 708 and the decoder model 712. Further, for training the encoder model 708 and the decoder model 712, the system 102 may be configured to receive a ground truth image (I_{¿}) 702 and a low-quality image (I_{LQ}) 704. The I_{¿} 702 may be a high-resolution image, such as the high-resolution image 410. For example, the I_{¿} 702 may be a high-resolution satellite image. The I_{LQ} 704 may be a low-resolution image of the second type. Furthermore, the I_{¿} 702 and the I_{LQ} 704 may be passed to a concatenation module 706. In an example, the low-quality image 704 may be the training first image 404. The training first image 404 and the high-resolution image 410 may be received from the database 104. The concatenation module 706 may be a neural network component that merges

multiple input tensors by concatenating them along a specified dimension. The input tensor represents a feature map extracted from an image. In an example, the tensor may be a mathematical object that generalizes scalars, vectors, and matrices to higher dimensions. In another example, the tensor may be an array of numbers arranged in a multi-dimensional grid, which can represent various types of data depending on its rank The concatenation module 706 may be used to combine different feature maps or representations to provide a richer set of features. The concatenation module 706 may be configured to receive the high-resolution image 410 and the training first image 404. Further, the concatenation module 706 may concatenate the high-resolution image 410 and the training first image 404. The concatenation module 706 may leverage detailed high-resolution features alongside the aggregated low-resolution features to improve the quality and accuracy of the low-resolution output. Further, the output of the concatenation module 706 may be fed to the encoder model 708.

In an embodiment, the concatenation module 706 is configured to receive a training first image, characterized by dimensions of [32, 64, 64], corresponding to 32 channels at a spatial resolution of 64×64 pixels, and a high-resolution image, which possesses dimensions of [64, 128, 128], indicating 64 channels at a spatial resolution of 128×128 pixels. The concatenation module 706 operates to concatenate the high-resolution image with the training first image 404 along the channel dimension. This operation yields a resultant tensor output with dimensions of [64+32, 128, 128], effectively combining the channel information from both images while maintaining the spatial resolution of 128×128 pixels. The resulting tensor output enables enhanced feature representation by integrating the information from both input images, thereby facilitating improved performance in subsequent processing tasks.

The encoder model 708 may be a neural network model that transforms an image into high-level feature representations using transformer mechanisms. Further, the encoder model 708 may be a Vision Transformer Encoder (VIT). The encoder model 708 may receive the output of the concatenation module 706. The encoder model 708 may be trained to generate a latent space (Z) 710 based on the output of the concatenation module 706. The latent space 710 is referred to as Z 710, hereinafter. The encoder model 708 may be trained to extract a set of key features from the output of the concatenation module 706. The set of key features may refer to high-level, abstract features that capture the essential information about the input image.

In an example, the encoder model 708 may be trained to split the input image into a series of positional embedding patches and then process these to generate the Z 710. In an example, the Z 710 may be a tensor representing a set of key features extracted from the input image. Further, the Z 710 may be transferred to the decoder model 712.

The decoder model 712 may be a neural network model. In an example, the decoder model 712 may be a transformer-based decoder that may be configured to generate a high-quality image. The high-quality image may be a high-resolution image 410 similar to the I_{¿} 702. The decoder model 712 may receive the Z 710 from the encoder model 708. The decoder model 712 may be trained to transform the Z 710 to the high-quality image. The high-quality image generated may be utilized by a plurality of ML models to, for example, generate map data, update map data, identify features of geographical regions, roads, road signs, etc.

In an example, a low-quality image is provided to the decoder model 712. The low-quality image provides the decoder model 712 with initial information about the image's structure and content. The utilization of low-quality images may assist the decoder model 712 in effectively understanding the characteristics and content of the image to be reconstructed or enhanced. Specifically, the decoder model 712 can leverage the inherent features and contextual information present in the low-quality image as a guiding reference during the reconstruction process. Further, the decoder model 712 is also provided with the Z 710 which may contain the set of key features referring to the high-level abstract features learned by the encoder model 708. These features represent the essential details and patterns extracted from the image that are not immediately visible in the low-quality image. By combining the low-quality image with the high-level feature extracted by the encoder model 708, the decoder model 712 may be trained to comprehend the context and intricate details necessary for generating a high-quality image 714. This training process enables the decoder model 712 to utilize the low-quality image as a reference point and refine it based on the detailed features provided by the encoder model 708.

FIG. 7B illustrates exemplary operations 700B for training the third neural network 102C, in accordance with an example embodiment of the present disclosure. FIG. 7B is explained in conjunction with elements of FIG. 1, FIG. 2, FIG. 3, FIG. 4, FIG. 5, FIG. 6 and FIG. 7A.

In an embodiment, the system 102 may be configured to train the third neural network 102C. Further for training the third neural network 102C, the system 102 may be configured to receive the I_{¿} 702 and the I_{LQ} 704. The I_{¿} 702 may be a high-resolution image 410 of the first type. The I_{LQ} 704 may be a low-resolution image of the second type. Furthermore, the I_{¿} 702 and the I_{LQ} 704 may be passed to the concatenation module 706.

In an example, the I_{¿} 702 may correspond to the high-resolution image 410 corresponding to the training first image of the first type. Moreover, the I_{LQ} 704 may correspond to the training third image 412 of the second type of low resolution. The training first image 404 and the training third image 412 may be received from the database 104.

Further, the encoder model 708 may generate the latent space, Z, 710 based on the output of the concatenation module 706. The Z 710 may be provided to a forward diffusion module 716.

The forward diffusion module 716 may be based on a forward diffusion process. The forward diffusion process refers to a generative mechanism that gradually transforms data into a uniform noise distribution through a series of steps. The forward diffusion module 716 may be trained to add gaussian noise on the latent space, Z, 710. In an example, the forward diffusion process gradually adds the gaussian noise to the latent representation. The forward diffusion module 716 may be trained to output a uniform noise distribution (Z_{T}) 718.

In an example, the forward diffusion module 716 may add the gaussian noise at each time step t, resulting in a sequence of noisy images, for example, x1, x2 . . . , xT. The xT may be a pure noise generated by the forward diffusion module 716. The xT may correspond to the Z_{T} 718.

FIG. 7C illustrates an exemplary operational diagram 700C for training the third neural network to remove the noise from enhanced images, in accordance with an example embodiment of the present disclosure. FIG. 7C is explained in conjunction with elements of FIG. 1, FIG. 2, FIG. 3, FIG. 4, FIG. 5, FIG. 6, FIG. 7A and FIG. 7B.

In an embodiment, the system 102 may be configured to utilize a denoising network 722 for training of the third neural network 102C. Further, for training the denoising network 722 the system 102 may be configured to receive the Z_{T} 718 from the forward diffusion module 716 and the I_{LQ} 704. The Z_{T} 718 may be the uniform noised distribution. The I_{LQ} 704 may be a low-resolution image of the second type. Furthermore, the I_{¿} 702 may be a high-resolution image of the first type. The I_{¿} 702 and the I_{LQ} 704 may be passed to the concatenation module 706.

In an embodiment, the system 102 may be configured to feed the I_{LQ} 704 to the encoder model 708. The encoder model 708 may generate a feature embedding 720. The feature embedding 720 may represent high-level features. Further, the feature embedding 720 may be passed to a denoising network 722. Details of the operation of the encoder model 708 is described, for example, in FIG. 7A.

In an embodiment, the system 102 may be configured to feed the feature embedding 720 and the ZT 718 to the denoising network 722. The denoising network 722 may be a specialized neural network trained to remove noise from data and restore the original, clean signal or image. During the training, the denoising network 722 takes a noisy input, which is a data sample that has been intentionally corrupted by noise. The noisy input may correspond to the ZT 718. The denoising network 722 may be trained to progressively denoise the noisy input back to the original image by estimating and removing noise at each time step, t. The denoising network 722 may be trained to predict the noise at each time step, t. The denoising network 722 takes the noisy input and produces an output that approximates the original, uncorrupted signal. The denoising network 722 may transfer the output to the decoder model 712.

In another example, the denoising network 722 is trained using noisy images at various time steps, t from the sequence generated by the forward diffusion module 716. Each training batch may randomly sample different time steps, t, and their corresponding noisy images. The denoising network 722 learns to predict the noise added at each time step t and is trained to minimize the error between the predicted noise and the xT (pure noise). Further, the denoising network 722 may transfer the output to the decoder model 712. In an embodiment, the decoder model 712 may receive the I_{LQ} 704 and the output of the denoising network 722. The decoder model 712 may generate the high-quality image based on the I_{LQ} 704\and the output of the denoising network 722. In an example, the high-quality image may be the training third image 412. Details of the operation of the decoder model 712 for generating the training third image 412 is described in conjunction with, for example, FIG. 7A, and has been omitted for sake of brevity.

FIG. 8 illustrates an exemplary block diagram 800 for generating the enhanced images utilizing the one or more neural networks, in accordance with an embodiment of the present disclosure. FIG. 8 is explained in conjunction with elements of FIG. 1, FIG. 2, FIG. 3, FIG. 4, FIG. 5, FIG. 6, FIG. 7A, FIG. 7B, and FIG. 7C.

In an embodiment, the system 102 may be configured to receive the image data 104A from the database 104. The image data 104A may be associated with the first image. The first image may be a low-resolution image of the first type. The first image may be the low-resolution satellite image. Further, the first image may be associated with the geographical region. The system 102 may transfer the image data 104A to the first neural network 102A.

In an embodiment, the first neural network 102A may receive the image data 104A. Further, the first neural network 102A may apply one or more processes on the image data 104A to generate the edge map data 104B. Further, the generated edge map data 104B may be fed to the second neural network 102B. The first neural network 102A may extract object contours and the most prominent visual edges from the image data 104A. Further, the first neural network 102A may extract features from the first image by applying different filters to the first image. The first neural network 102A may identify edges, lines, curves, and other features from the first image. The edge map data 104B may be a visual representation that highlights the edges or boundaries within the first image.

Further, the second neural network 102B is configured to generate a second image 802 based on the edge map data 104B. The second image 802 may correspond to the second type which may be different from the first type of the first image.

For example, the second neural network 102B is configured to identify a first set of parameters associated with the first image based on the image data 104A. The first set of parameters may include at least a color, a gradient, or a spatial resolution. Further, the second image 802 is generated associated with the geographical region based on the first set of parameters and the edge map data 104B.

Further, the third neural network 102C is configured to receive the second image 802 from the second neural network 102B. The third neural network 102C may generate the third image 104C based on the received second image 802. Further, the third neural network 102C may be trained to identify a second set of parameters. The second set of parameters may include at least a spatial resolution. The third image 104C may be generated based on the second set of parameters. The third image 104C may correspond to a format, i.e., the second type, similar to that of the second image. In an example, the third neural network 102C may be trained to increase a resolution of the second image 802. The third neural network 102C may increase the resolution of the second image 802 from a first resolution to a second resolution. The second resolution may be greater than the first resolution.

At the end, the system 102 may be configured to use a plurality of ML models to generate the map data 106. The map data 106 may be generated using the third image 104C received from the third neural network 102C. In an example, an object detection model may be configured to generate the edge map data 104B. The object detection model may receive the third image 104C and generate a set of feature points. The set of feature points may be used in generating the map data 106.

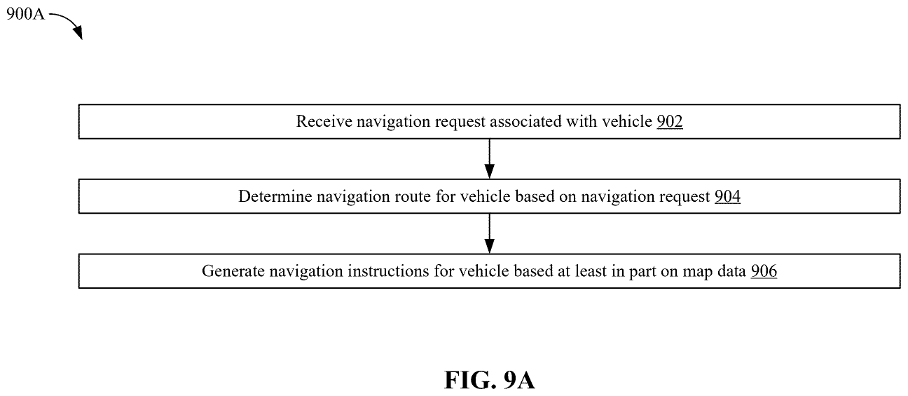

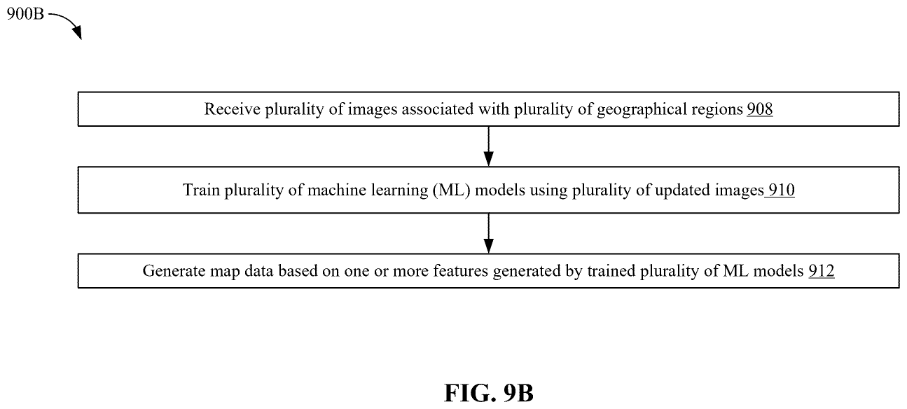

FIG. 9A illustrates an exemplary flowchart 900A of a method for generating navigational instructions using the map data 106, in accordance with an example embodiment the present disclosure. The exemplary operations illustrated in the flowchart 900A may start at 902 and may be performed by any computing system, apparatus, or device, such as by the system 102 of FIG. 1 or the processor 202 of FIG. 2

At 902, a navigation request associated with a vehicle is received. In an embodiment the system 102 may be configured to receive the navigation request associated with the vehicle. The navigation request may include a source location and a destination location. The navigational request may be initiated by a user particularly a user device associated with the user. The source location may refer to an initial point or starting position from which the navigation process begins. The source location may be the specific geographical coordinate, address, or place that serves as the origin for the navigation request. In an example, the source location might be the user current location. The destination location may refer to an endpoint or target location that the navigation request aims to reach. The destination location may provide the specific geographical coordinate, address, or place where the user or system intends to arrive.

In an example the vehicle may correspond to a non-autonomous vehicle, a semi-autonomous vehicle, or a fully autonomous vehicle, for example, as defined by National Highway Traffic Safety Administration (NHTSA). Examples of each vehicle of the set of vehicles may include but are not limited to, a two-wheeler vehicle, a three-wheeler vehicle, a four-wheeler vehicle, more than a four-wheeler vehicle, an electric vehicle, a hybrid vehicle, or a vehicle with autonomous drive capability that uses one or more distinct renewable or non-renewable power sources.

At 904, a navigation route is determined for the vehicle based on the navigation request. In an embodiment, the system 102 is configured to determine the navigation route for the vehicle based on the navigation request. The navigational route may be a planned path or a sequence of directions that guide the user from the source location to the destination location. The navigation route comprises a combination of link segments within the geographical region. A link segment refers to a specific portion or section of the route that connects two distinct waypoints or nodes. Further, the route segment may represent a discrete segment of the overall path, typically defined by the roads, paths, or corridors between intersections or landmarks.

In an embodiment, the navigational route may be determined based on the map data 106 generated by utilizing the one or more neural networks and the plurality of ML models. The map data 106 may be generated by the plurality of ML models by utilizing the enhanced images, such as the third images of various geographic regions. Due to enhanced nature of the third images, accuracy of output of plurality of ML models is improved, thereby improving quality and accuracy of map data 106 and the navigation route.

At 906, navigation instructions are generated based on the navigation route. In an embodiment, the system 102 is configured to generate the navigation instructions for the vehicle based on the map data 106 and the navigational route. The navigation instructions may refer to specific, actionable directions provided to guide the user from the source location to the destination location along the determined navigational route. The navigational instructions may be generated to control the vehicle to follow the navigational route to traverse from the source location to the destination location.

FIG. 9B illustrates an exemplary flowchart 900B of a method for training a plurality of ML models for generating the map data 106. FIG. 9B is explained in conjunction with elements of FIG. 9A. The exemplary operations illustrated in the flowchart 900B may start at 908 and may be performed by any computing system, apparatus, or device, such as by the system 102 of FIG. 1 or the processor 202 of FIG. 2

At 908, a plurality of images is received. In an embodiment, the system 102 may be configured to receive the plurality of images associated with the plurality of geographical regions. Each of the plurality of images may be associated with the second type. At least one image of the plurality of images may correspond to each geographical region from the plurality of geographical regions. Fo example, the plurality of images may include the third image 104C. In an example, the third image 104C may be associated with a first geographical region. The third image 104C may be the high-resolution image of the second type.

At 910, a plurality of ML models is trained based on the plurality of images. In an embodiment, the system 102 may be configured to train the plurality of ML models using the plurality of images. Each of the plurality of ML models are trained to generate one or more features of each of the plurality of geographical regions. The plurality of ML models may be trained based on the third image 104C corresponding to the first geographical region for generating one or more features of the first geographical region. Further, the plurality of images may be associated with the plurality of geographical regions.

At 912, map data 106 is generated based on the trained plurality of ML models. In an embodiment, the system 102 may be configured to generate the map data 106 based on the one or more features generated by the trained plurality of ML models. In an example, the map data 106 may include lane data records, intersection data records, road sign data records, traffic signals data records, or other data that may represent links in navigation routes, pedestrian lanes, or areas in addition to or instead of the vehicle lanes. Further, the map data 106 may be associated with the plurality of geographical regions.

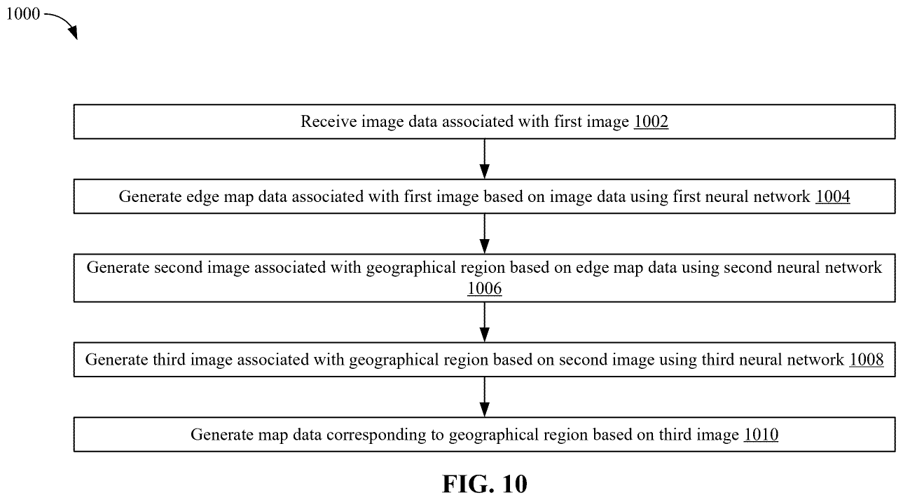

FIG. 10 illustrates an exemplary flowchart 1000 of a method for generating enhanced images, in accordance with an example embodiment of the present disclosure. FIG. 10 is explained in conjunction with FIG. 1, FIG. 2, FIG. 3, FIG. 4, FIG. 5, FIG. 6, FIG. 7A, FIG. 7B, FIG. 7C, FIG. 8 and FIG. 9. The operations of the exemplary method may be executed by any computing system, for example, by the system 102 of FIG. 1 or the processor 202 of FIG. 2. The operations of the flowchart 1000 may start at 1002.

At 1002, image data associated with a fist image is received. In an embodiment, the system 102 is configured to receive the image data 104A associated with the first image. The first image may have the first type. The first image is associated with a geographical region.

At 1004, edge map data is generated based on the image data. In an embodiment, the system 102 is configured to generate the edge map data 104B associated with the first image based on the image data 104A. The system 102 may generate the edge map data 104B using the first neural network 102A.

At 1006, a second image is generated based on the edge map data. In an embodiment, the system 102 is configured to generate the second image 802 associated with the geographical region based on the edge map data 104B. The second image 802 may have a second type. The second type is different from the first type. The second image 802 is generated using the second neural network 102B. Further, the second neural network 102B is trained on the latent representation of each of a plurality of training images associated with a plurality of geographical regions. Each training image of the plurality of training images is associated with the second type. In an example, the first type corresponds to an imaging format of images collected by satellites, while the second type corresponds to an imaging format of images collected by probe equipment.

At 1008, a third image is generated based on the second image. In an embodiment, the system 102 is configured to generate the third image 104C associated with the geographical region based on the second image 802. The third image 104C is generated using the third neural network 102C. The third image 104C may have the first resolution higher than the second resolution of the second image 802.

At 1010, map data is generated based on the third image. In an embodiment, the system 102 is configured to generate the map data 106 corresponding to the geographical region based on the third image 104C.

Accordingly, blocks of the flowchart 1000 support combinations of means for performing the specified functions and combinations of operations for performing the specified functions. It will also be understood that one or more blocks of the flowchart 1000, and combinations of blocks in the flowchart 1000, can be implemented by special-purpose hardware-based computer systems which perform the specified functions, or combinations of special-purpose hardware and computer instructions.

Alternatively, the system 102 may comprise means for performing each of the operations described above. In this regard, according to an example embodiment, examples of means for performing operations may comprise, for example, the processor and/or a device or circuit for executing instructions or executing an algorithm for processing information as described above.

Returning to FIG. 1, the mapping platform 108 may comprise suitable logic, circuitry, and interfaces that may be configured to store map data generated by the one or more neural networks. The mapping platform 108 may be configured to store and update map data indicating the traffic data along with other map attributes, road attributes, and traffic entities, in the map database 108B. The mapping platform 108 may include techniques related to, but not limited to, geocoding, routing (multimodal, intermodal, and unimodal), clustering algorithms, machine learning in location-based solutions, natural language processing algorithms, and artificial intelligence algorithms. Data for different modules of the mapping platform 108 may be collected using a plurality of technologies including, but not limited to drones, sensors, connected cars, cameras, probes, and chipsets. In some embodiments, the mapping platform 108 may be embodied as a chip or chip set. In other words, the mapping platform 108 may comprise one or more physical packages (such as chips) that include materials, components, and/or wires on a structural assembly (such as a baseboard).

In some example embodiments, the mapping platform 108 may include the processing server 108A for carrying out the processing functions associated with the mapping platform 108 and the mapping for storing map data 106. In an embodiment, the processing server 108A may include one or more processors configured to process requests received from the system 102 102. The processors may fetch sensor data and/or map data from the mapping database 104 108B and transmit the same to the system 102 in a format suitable for use by the system 102.

Continuing further, the map database 108B may comprise suitable logic, circuitry, and interfaces that may be configured to store the map data 106, which may be collected from the low-resolution satellite. The map database 108B may store node data, road segment data, link data, point of interest (POI) data, link identification information, heading value records, data about various geographic zones, regions, pedestrian data for different regions, heat maps or the like. Also, the map database 108B further includes speed limit data of different lanes, cartographic data, routing data, and/or maneuvering data. Additionally, the map database 108B may be updated dynamically to accumulate real time traffic data. The real time traffic data may be collected by analyzing the location transmitted to the mapping platform 108 by a large number of road users through the respective user devices of the road users. In one example, by calculating the speed of the road users along a length of the road, the mapping platform 108 may generate a live traffic map, which is stored in the map database 108B in the form of real time traffic conditions. In an embodiment, the map database 108B may store data from different zones in a region. In one embodiment, the map database 108B may further store historical traffic data that includes travel times and average speeds on each road or area at any given time of the day and any day of the year. In an embodiment, the map data in the map database 108B may be in the form of map tiles. Each map tile may denote a map tile area including a plurality of road segments or links within the map tile. According to some example embodiments, the road segment data records may be links or segments representing roads, streets, or paths, as may be used in calculating a route or recorded route information for the determination of one or more personalized routes. The node data may be ending points corresponding to the respective links or segments of road segment data. The road link data and the node data may represent a road network used by vehicles such as cars, trucks, buses, motorcycles, and/or other entities. Optionally, the map database 108B may contain path segment and node data records, such as shape points or other data that may represent pedestrian paths, links, or areas in addition to or instead of the vehicle road record data, for example. The road/link and nodes may be associated with attributes, such as geographic coordinates, street names, address ranges, speed limits, turn restrictions at intersections, and other navigation related attributes.

Further, the map database 108B may also store data about the POIs and their respective locations in the POI records. The map database 108B may additionally store data about places, such as cities, towns, or other communities, and other geographic features such as bodies of water, mountain ranges, etc. Such place or feature data may be part of the POI data or may be associated with POIs or POI data records (such as a data point used for displaying or representing a position of a city). In addition, the map database 108B may include event data (e.g., traffic incidents, construction activities, scheduled events, unscheduled events, accidents, diversions, etc.) associated with the POI data records or other records of the map database 108B associated with the mapping platform 108. Optionally, the map database 108B may contain path segment records and node data records or other data that may represent pedestrian paths or areas in addition to or instead of the autonomous vehicle road record data.

Furthermore, the data stored in the map database 108B may be compiled (such as into a platform specification format (PSF)) to organize and/or processed for generating navigation-related functions and/or services, such as route calculation, route guidance, map display, speed calculation, distance and travel time functions, navigation instruction generation, and other functions, by a navigation device, such as a user equipment. The navigation-related functions may correspond to vehicle navigation, pedestrian navigation, navigation to a favored parking spot, or other types of navigation. While example embodiments described herein generally relate to vehicular travel, example embodiments may be implemented for bicycle travel along bike paths, boat travel along maritime navigational routes, etc. The compilation to produce the end-user database may be performed by a party or entity separate from the map developer. For example, a customer of the map developer, such as a navigation device developer or other end user device developer, may perform compilation on the received map database 108B in a delivery format to produce one or more compiled navigation databases. In some embodiments, the map database 108B may be a master geographic database configured on the side of the system 102. In accordance with an embodiment, the map database 108B may represent a compiled navigation database that may be used in or with end-user devices to provide navigation instructions based on the traffic data, the traffic conditions, speed adjustment, ETAs, and/or map-related functions to navigate through the intersection connected links on the route.

In an example, the system 102 may be embodied as a cloud-based service, a cloud-based application, a cloud-based platform, a remote server-based service, a remote server-based application, a remote server-based platform, or a virtual computing system. In yet another example embodiment, the system 102 may be an OEM (Original Equipment Manufacturer) cloud. The OEM cloud may be configured to anonymize any data received by the system 102, before using the data for further processing, such as before sending the data to the database 104 In an example, anonymization of the data may be done by the mapping platform 108.

The communication network 110 may be wired, wireless, or any combination of wired and wireless communication networks, such as cellular, Wi-Fi, internet, local area networks, or the like. In some embodiments, the communication network 110 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (for e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof.

Returning to FIG. 2, the processor 202 may be embodied in a number of different ways. For example, the processor 202 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processor may enable multiprocessing within a single physical package. Additionally, or alternatively, the processor 202 may include one or more processors configured in tandem via the bus to enable independent execution of instructions, pipelining, and/or multithreading. Additionally, or alternatively, the processor 202 may include one or more processors capable of processing large volumes of workloads and operations to provide support for big data analysis. In an example embodiment, the processor 202 may be in communication with the memory 204 via a bus for passing information among components of the system 102.

The memory 204 may be non-transitory and may include, for example, one or more volatile and/or non-volatile memories. In other words, for example, the memory 204 may be an electronic storage device (for example, a computer readable storage medium) comprising gates configured to store data (for example, bits) that may be retrievable by a machine (for example, a computing device like the processor 202). The memory 204 may be configured to store information, data, content, applications, instructions, or the like, for enabling the system 102 102 to carry out various functions in accordance with an example embodiment of the present disclosure. For example, the memory 204 may be configured to buffer input data for processing by the processor 202. As exemplarily illustrated in FIG. 2, the memory 204 may be configured to store instructions for execution by the processor 202. As such, whether configured by hardware or software methods, or by a combination thereof, the processor 202 may represent an entity (for example, physically embodied in circuitry) capable of performing operations according to an embodiment of the present disclosure while configured accordingly. Thus, for example, when the processor 202 is embodied as an ASIC, FPGA, or the like, the processor 202 may be specifically configured hardware for conducting the operations described herein.

Alternatively, as another example, when the processor 202 is embodied as an executor of software instructions, the instructions may specifically configure the processor 202 to perform the algorithms and/or operations described herein when the instructions are executed. However, in some cases, the processor 202 may be a processor specific device (for example, a mobile terminal or a fixed computing device) configured to employ an embodiment of the present disclosure by further configuration of the processor 202 by instructions for performing the algorithms and/or operations described herein. The processor 202 may include, among other things, a clock, an arithmetic logic unit (ALU), and logic gates configured to support the operation of the processor 202. The network environment, such as 100 may be accessed using the I/O interface 206 of the system 102. The I/O interface 206 may provide an interface for accessing various features and data stored in the system 102.

In some example embodiments, the I/O interface 206 may communicate with the system 102 and display the input and/or output of the system 102. As such, the I/O interface 206 may include a display and, in some embodiments, may also include a keyboard, a mouse, a joystick, a touch screen, touch areas, soft keys, one or more microphones, a plurality of speakers, or other input/output mechanisms. In one embodiment, the system 102 102 may comprise user interface circuitry configured to control at least some functions of one or more I/O interface elements such as a display and, in some embodiments, a plurality of speakers, a ringer, one or more microphones and/or the like. The processor 202 and/or I/O interface 206 circuitry may be configured to control one or more functions of one or more I/O interface 206 elements through computer program instructions (for example, software and/or firmware) stored on a memory 204 accessible to the processor 202.

In some embodiments, the processor 202 may be configured to provide Internet-of-Things (IoT) related capabilities to users of the system 102 disclosed herein. The IoT related capabilities may in turn be used to provide smart city solutions by providing real time navigation output, big data analysis, and sensor-based data collection by using the cloud-based mapping system for determining the difficulty factor for the geographic zone. The I/O interface 206 may provide an interface for accessing various features and data stored in the system 102.

Many modifications and other embodiments of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A system comprising:
a memory configured to store computer executable instructions; and
one or more processors configured to execute the computer executable instructions to:
receive image data associated with a first image, the first image having a first type, wherein the first image is associated with a geographical region;
generate, using a first neural network, edge map data associated with the first image based on the image data;
generate, using a second neural network, a second image associated with the geographical region based on the edge map data, the second image having a second type different from the first type, wherein the second neural network is trained on a latent representation of each of a plurality of training images associated with a plurality of geographical regions, and wherein each training image of the plurality of training images is associated with the second type;
generate, using a third neural network, a third image associated with the geographical region based on the second image, the third image having a first resolution higher than a second resolution of the second image; and
generate map data corresponding to the geographical region based on the third image.

2. The system of claim 1, wherein, to train the second neural network, the one or more processors are further configured to:
receive the plurality of training images associated with the plurality of geographical regions, wherein each training image of the plurality of training images is associated with the second type;
generate, using the first neural network, training edge map data associated with each training image of the plurality of training images;
re-generate, using the second neural network, a training second image corresponding to each training image of the plurality of training images based on the training edge map data and the plurality of training images; and
generate, using the third neural network, a plurality of training third images based on the re-generated training second image corresponding to each training image of the plurality of training images and a high-resolution image corresponding each training image of the plurality of training images.

3. The system of claim 2, wherein, to train the second neural network, the one or more processors are further configured to:
identify a set of training parameters associated with each training image of the plurality of training images; and
re-generate, using the second neural network, the training second image corresponding to each training image of the plurality of training images based on the training edge map data and the set of training parameters.

4. The system of claim 3, wherein the set of training parameters associated with a training image of the plurality of training images comprises at least one of: a color, a gradient, or a spatial resolution.

5. The system of claim 1, wherein the first image is a low-resolution image of the first type, and wherein the second image is a low-resolution image of the second type.

6. The system of claim 1, wherein the first image is a satellite image.

7. The system of claim 1, wherein the one or more processors are further configured to:
receive, using the second neural network, the edge map data associated with the first image;
determine, using the second neural network, a first set of parameters associated with the first image based on the image data; and
generate, using the second neural network, the second image associated with the geographical region based on the first set of parameters and the edge map data.

8. The system of claim 1, wherein the first neural network is a convolution neural network (CNN).

9. The system of claim 1, wherein the second neural network is a generative adversarial network (GAN).

10. The system of claim 1, wherein the third neural network is a diffusion model.

11. The system of claim 1, wherein the one or more processors are further configured to:
update the map data corresponding to the geographical region based on the third image.

12. The system of claim 1, wherein the one or more processors are further configured to:
receive a plurality of images associated with the plurality of geographical regions, the plurality of images being associated with the first type, wherein each of the plurality of images correspond to at least one geographical region from the plurality of geographical regions, and wherein the plurality of images comprises the first image;
generate a plurality of updated images corresponding to the plurality of geographical regions based on the plurality of images, wherein the plurality of updated images comprise the third image associated with the geographical region;
train a plurality of machine learning (ML) models using the plurality of updated images, wherein each of the plurality of ML models are trained to generate one or more features of each of the plurality of geographical regions; and
generate the map data based on the one or more features generated by the trained plurality of ML models.

13. A method comprising:
receiving a plurality of training images associated with a plurality of geographical regions, wherein each training image of the plurality of training images is associated with a second type;
generating, using a first neural network, training edge map data associated with each training image of the plurality of training images;
training a second neural network to re-generate a training second image corresponding to each training image of the plurality of training images based on the training edge map data and the plurality of training images; and
generating, using a third neural network, a plurality of training third images based on the re-generated training second image corresponding to each training image of the plurality of training images and a high-resolution image corresponding each training image of the plurality of training images.

14. The method of claim 13, wherein, to train the second neural network, the method further comprises:
identifying a set of training parameters associated with each training image of the plurality of training images; and
training the second neural network to re-generate the training second image corresponding to each training image of the plurality of training images based on the training edge map data and the set of training parameters.

15. The method of claim 14, wherein the set of training parameters associated with a training image of the plurality of training images comprises at least one of: a color, a gradient, or a spatial resolution.

16. The method of claim 14, further comprising:
receiving image data associated with a first image, the first image having a first type, wherein the first image is associated with a geographical region;
generating, using the first neural network, edge map data associated with the first image based on the image data;
generating, using the second neural network, a second image associated with the geographical region based on the edge map data, the second image having a second type different from the first type, wherein the second neural network is trained on a latent representation of each training image of the plurality of training images associated with the plurality of geographical regions;
generating, using the third neural network, a third image associated with the geographical region based on the second image, the third image having a first resolution higher than a second resolution of the second image; and
generating map data corresponding to the geographical region based on the third image.

17. The method of claim 16, wherein the first image is a low-resolution image of the first type, and wherein the second image is a low-resolution image of the second type.

18. The method of claim 16, further comprising updating the map data corresponding to the geographical region based on the third image.

19. A computer programmable product comprising a non-transitory computer readable medium having stored thereon computer executable instructions, which when executed by one or more processors, cause the one or more processors to carry out operations comprising:
receiving image data associated with a first image, the first image having a first type, wherein the first image is associated with a geographical region;
generating, using a first neural network, edge map data associated with the first image based on the image data;
generating, using a second neural network, a second image associated with the geographical region based on the edge map data, the second image having a second type different from the first type, wherein the second neural network is trained on a latent representation of each of a plurality of training images associated with a plurality of geographical regions, and wherein each training image of the plurality of training images is associated with the second type;
generating, using a third neural network, a third image associated with the geographical region based on the second image, the third image having a first resolution higher than a second resolution of the second image; and
generating map data corresponding to the geographical region based on the third image.

20. The computer programmable product of claim 19, wherein the operations further comprise:
receiving the plurality of training images associated with the plurality of geographical regions, wherein each training image of the plurality of training images is associated with the second type;
generating, using the first neural network, training edge map data associated with each training image of the plurality of training images;
re-generating, using the second neural network, a training second image corresponding to each training image of the plurality of training images based on the training edge map data and the plurality of training images; and
generating, using the third neural network, a plurality of training third images based on the re-generated training second image corresponding to each training image of the plurality of training images and a high-resolution image corresponding each training image of the plurality of training images.
